(19) United States
(12) Patent Application Publication
(10) Pub. No.: US 2009/0250348 A1
(43) Pub. Date: Oct. 8, 2009

(54) Droplet microfluidic transporting module

(75) Inventors: Wen-Syang Hsu, Hsinchu (TW); Han-Ping Young, Hsinchu (TW); Shih-Kang Fan, Hsinchu (TW)

Correspondence Address: BACON & THOMAS, PLLC, 625 SLATERS LANE, FOURTH FLOOR, ALEXANDRIA, VA, 22314-1176, US

(73) Assignee: NATIONAL CHIAO TUNG UNIVERSITY, HSINCHU (TW)

(21) Appl. No.: 12/289,544

(22) Filed: Oct. 30, 2008

(30) Foreign Application Priority Data
Apr. 8, 2008 (TW) 97112718

(51) Int. Cl. B01J 19/08

(52) U.S. Cl. 204/601

(57) ABSTRACT

A droplet microfluidic transporting module adapted for transporting a droplet is disclosed to include one or a number of connectors and one or a number of microfluidic transporting platform. Each connector defines a passage extending in one or multiple predetermined directions, and a first driving electrode extending along one side of the passage for the contact of the droplet to be transported. The microfluidic transporting platform is detachably electrically connected with the connector, defining a channel in communication with the passage of the connector and having a second driving electrode extending along one side of the channel for the contact of the droplet to be transported.

### BACKGROUND OF THE INVENTION

1. Field of the Invention

The present invention relates to microanalysis systems and more particularly to a droplet microfluidic transporting module for transporting one or several droplets.

2. Description of the Related Art

The demand for microanalysis system (for example, biochip) for biomedical analysis and biochemical examination is increasing daily. In a biomedical analysis system or biochemical examination system, the microfluidic transporting platform that is used for transporting sample (or specimen) has a great concern with the analysis performance and result.

Comparing to the conventional continuous microfluidic platform, the droplet-based microfluidic platform developed rapidly in recent years, since it can handle small amount of sample and does not need any movable components in the platform. These characteristics make the droplet-based microfluidic platform attractive for miniaturized biomedical analysis or examination systems. However, in order to develop a miniaturized biomedical analysis or examination systems, lots of components or subsystems need to be integrated, such as sensor units, analysis units, and microfluidic components. With the increasing complexity on such systems, these components or subsystems are often manufactured separately, then proper assembly techniques are needed, especially between different droplet microfluidic platforms. Furthermore, if the integration is achieved in a planner form, the device or system may still occupy a large area.

### SUMMARY OF THE INVENTION

The present invention has been accomplished under the circumstances in view. It is the main object of the invention to provide droplet microfluidic transporting module, which utilizes a detachable and plug-and-play interface design between a connector and a microfluidic transporting platform, facilitating synthesis of a complicated analysis system and alteration of analysis modules.

To achieve this and other objects of the present invention, the droplet microfluidic transporting module is adapted for transporting one or several droplets, comprising at least one connector and at least one microfluidic transporting platform. Each connector comprises at least one passage extending in at least one predetermined direction, and a first driving electrode extending along one side of each passage for the contact of the droplet to be transported. The at least one microfluidic transporting platform is detachably electrically connected with the at least one connector, each comprising a channel in communication with the at least one passage of the at least one connector and a second driving electrode extending along one side of the channel for the contact of the droplet to be transported.

Thus, the invention connects at least one connector to at least one microfluidic transporting platform to constitute a microfluidic transporting module for the connection of different analysis systems and for synthesis of a complicated analysis system.

### BRIEF DESCRIPTION OF THE DRAWING

FIG. 1 is a schematic drawing showing a droplet microfluidic transporting module in accordance with a first embodiment of the present invention.

FIG. 2 shows a modified arrangement of the droplet microfluidic transporting module in accordance with the first embodiment of the present invention for 2-D direction droplet movement.

FIG. 3 is a schematic drawing showing a droplet microfluidic transporting module in accordance with a second embodiment of the present invention.

FIG. 4 is a perspective view in an enlarged scale of a part of FIG. 3

FIG. 5 is a schematic drawing showing a droplet microfluidic transporting module in accordance with a third embodiment of the present invention.

### DETAILED DESCRIPTION OF THE INVENTION

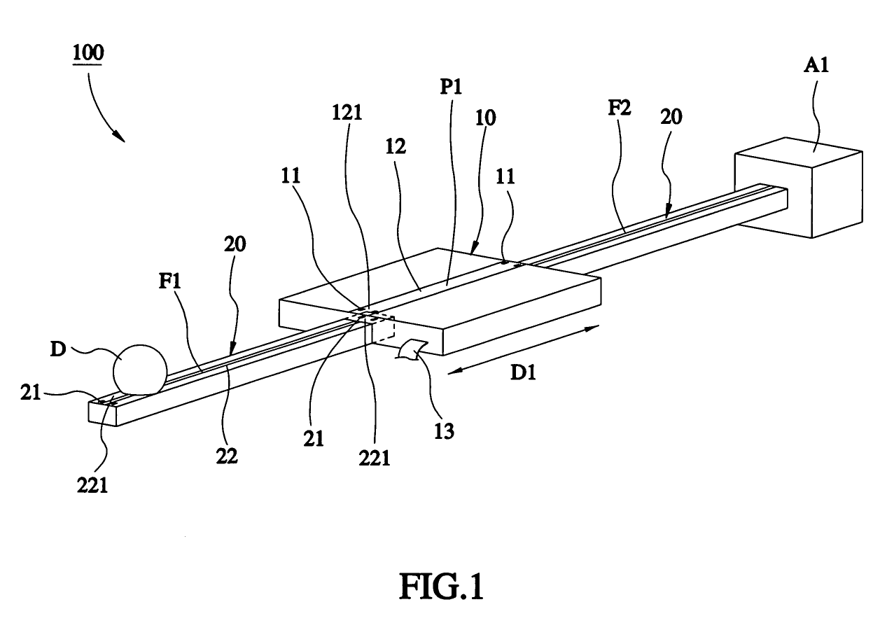

Referring to FIG. 1, a droplet microfluidic transporting module 100 in accordance with a first embodiment of the present invention is shown for transporting a droplet D to a fluidic analysis unit A1 for analysis, comprising a connector 10 and two microfluidic transporting platforms 20.

The connector 10 is a plate member covered with a conducting membrane, (for example, indium tin oxides conducting membrane), comprising two first connection electrodes 11 respectively disposed at the two distal ends thereof, a first driving electrode 12 formed between the first connection electrodes 11 and defining an intersection area 121 at each of the two distal ends of the plate member, a passage P1 defined above the first driving electrode 12 in a one-dimensional direction D1, and an input/output terminal 13 electrically connected to the first driving electrode 12 for transmitting signal and receiving external power supply so that the electrodes 11 and 12 can receive external power supply. Further, the first driving electrode 12 is controllable by a program to apply a voltage to the droplet D, controlling the movement of the droplet D.

The microfluidic transporting platforms 20 are narrow elongated platforms respectively prepared from a flexible polymer substrate (for example, poly ethylene terephthalate) and coated with a layer of conducting membrane (for example, indium tin oxides conducting membrane). Each microfluidic transporting platform 20 comprises two second connection electrodes 21 respectively disposed at the two distal ends thereof, a second driving electrode 22 formed between the two second connection electrodes 21 and defining with each of the two distal ends of the plate member a respective intersection area 221, and a channel F1 defined above the second driving electrode 22 in communication with the passage P1 of the connector 10.

In actual use, we can detachably connect the connector 10 or the microfluidic transporting platforms 20 to (the male or female connector of) the fluidic analysis unit A1 to have the passage P1 or channel F2 in communication with the inside of the fluidic analysis unit A1, and then connect the input/output terminal 13 of the connector 10 to an external control apparatus and power supply device, and then detachably connect the microfluidic transporting platforms 20 to the connector 10 by, for example, snap means to have the second connection electrodes 21 be electrically connected with the first connection electrodes 11 and the intersection areas 121 of the connector 10 be abutted against one intersection area 221 of each of the microfluidic transporting platforms 20. When installed, the second driving electrode 22 is controllable by a program to output a voltage, i.e., to support the plug-and-play function, causing the droplet D to move in proper order, subject to an electrowetting effect, along the left channel F1, the intersection areas 121 and 221, the passage P1 and the right channel F2 to the inside of the fluidic analysis unit A1 for further analysis operation.

It is to be understood that the right-sided microfluidic transporting platform 20 can be eliminated from the droplet microfluidic transporting module 100 and the connector 10 can be directly and electrically connected to the fluidic analysis unit A1, achieving the same droplet D transporting effect. Further, when wishing to change the target sample to be analyzed, a matching fluidic analysis unit is used to substitute for the fluidic analysis unit A1 without changing the whole analysis system like conventional techniques, i.e., the droplet microfluidic transporting module 100 of the present invention can be used repeatedly, facilitating analysis operation and saving much time.

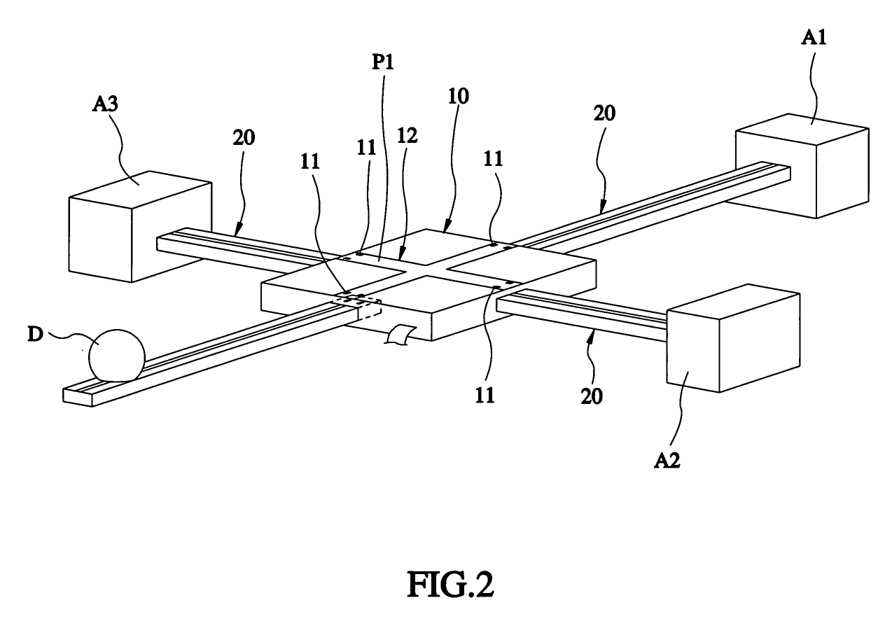

Of course, the first driving electrode 12 and the first connection electrodes 11 can extend in two-dimensional directions, as shown in FIG. 2 and in consequence, the passage P1 extends in two-dimensional directions for enabling the droplet D to be moved in two-dimensional directions. Thus, the connector 10 can be connected with at least three fluidic analysis units A1˜A3 either directly or through the microfluidic transporting platforms 20, improving analysis performance, saving much time and, simplifying the operation procedure.

As stated above, the invention provides a detachable and plug-and-play interface design of the connector 10 and microfluidic transporting platforms 20, facilitating synthesis of a complicated analysis system and alteration of analysis modules.

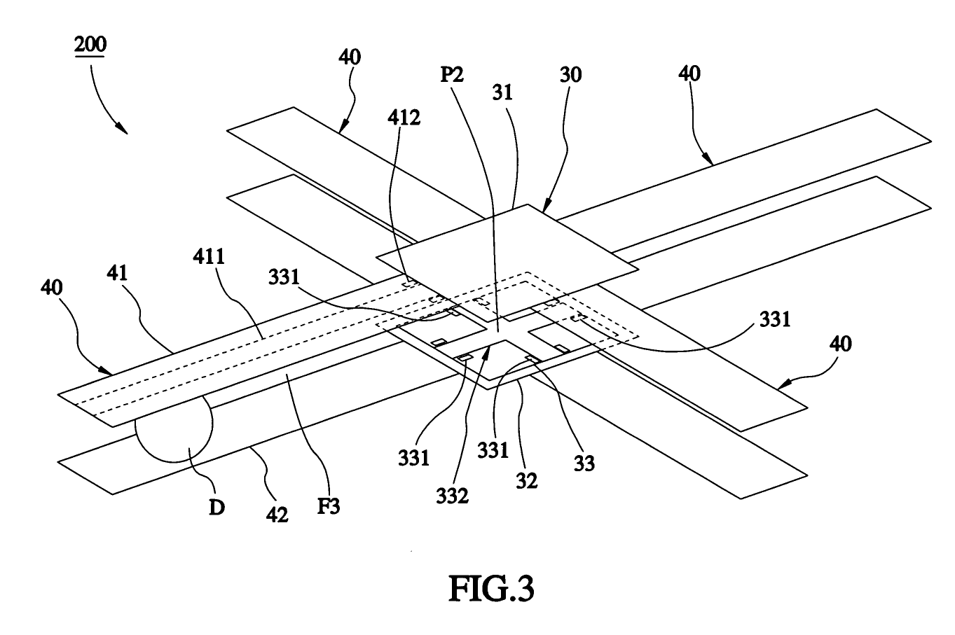

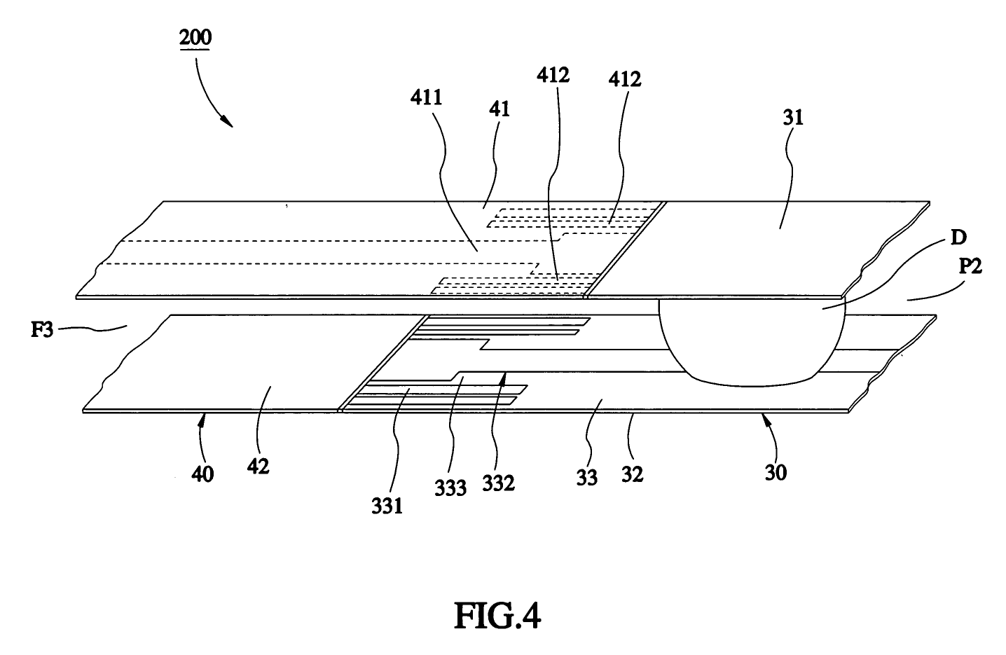

Referring to FIGS. 3 and 4, a droplet microfluidic transporting module 200 in accordance with a second embodiment of the present invention is shown similar to the structural arrangement shown in FIG. 2, i.e., the passage of the connector of this second embodiment extends in two-dimensional directions for allowing transmission of a droplet on a two-dimensional plane, with the exception that the connector 30 and the microfluidic transporting platforms 40 according to this second embodiment commonly have a double-plate transporting structure.

According to this second embodiment, the connector 30 comprises a top plate 31, a bottom plate 32, and a control substrate 33 arranged on the top side of the bottom plate 32. The control substrate 33 comprises a first connection electrode 331 at each of the four sides thereof, a cross-shaped first driving electrode 332 arranged on the top surface thereof, a passage P2 defined above the first driving electrode 332 between the top plate 31 and the bottom plate 32, and an intersection area 333 defined between the first driving electrode 332 and each first connection electrode 331. Further, each microfluidic transporting platform 40 comprises a top plate 41 and a bottom plate 42. The top plate 41 comprises a second driving electrode 411 and a second connection electrode 412, and a channel F3 defined below the second driving electrode 411 between the top plate 41 and the bottom plate 42. The bottom plate 42 has a water-repellent layer (not shown) on the surface thereof.

By means of the aforesaid structure, a droplet D can be transported on a two-dimensional plane steadily. In addition, the connector 30 is connectable with at least three fluidic analysis units (the number of fluidic analysis units is relatively increased when increasing the connector amount). Therefore, when compared to conventional designs, the invention effectively improves analysis performance, saves much time and, simplifies the operation procedure.

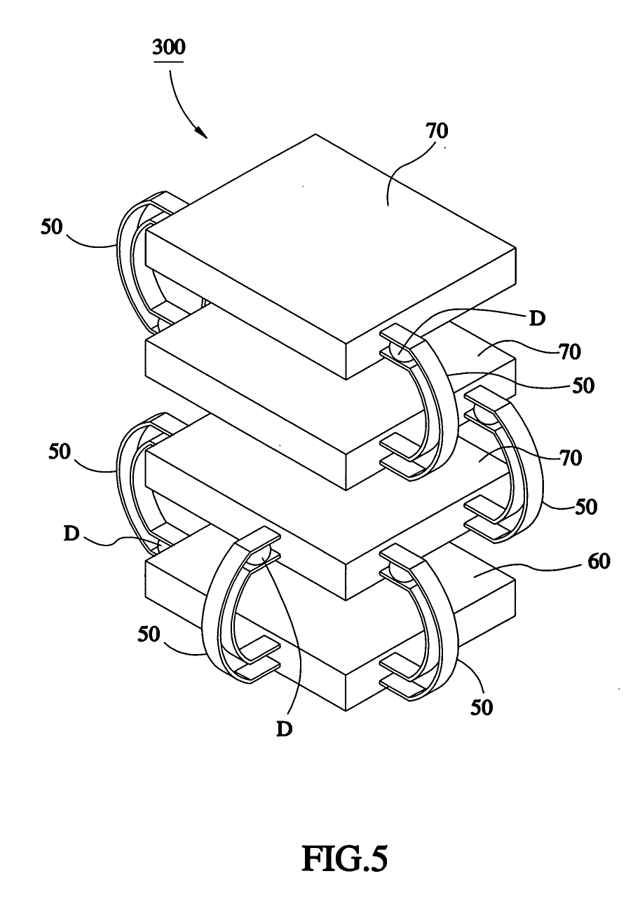

FIG. 5 shows a droplet microfluidic transporting module 300 in accordance with a third embodiment of the present invention. This third embodiment is substantially similar to the aforesaid second embodiment with the exception that the flexible material property of the microfluidic transporting platforms 50 allows multiple connectors 60 and substrates 70 (for example, biochips) to be stacked up to constitute a three-dimensional fluidic receiver system so that multiple droplets D can be moved along the microfluidic transporting platforms 50 in three-dimensional directions. Thus, the invention effectively reduces analysis system space occupation, facilitating fabrication of a multipurpose micro biochemical and biomedical analysis and examination system, and providing convenience for use and carrying. Further, the interface design of the connectors 60 and the microfluidic transporting platforms 50 allows connection of different analysis platforms (for example, substrates 70) to be connected together by the connectors 60 or the microfluidic transporting platforms 50 without changing the design or using external adapter means. Therefore, the invention facilitates assembling or replacement of different analysis platforms (substrates 70) so that the whole analysis system is highly expandable for wide range application.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A droplet microfluidic transporting module for transporting one or several droplets, comprising:
at least one connector, each said connector comprising at least one passage extending in at least one predetermined direction and a first driving electrode extending along one side of each said passage for the contact of the droplet to be transported; and
at least one microfluidic transporting platform detachably and electrically connected with said at least one connector, each said microfluidic transporting platform comprising a channel in communication with the at least one passage of said at least one connector and a second driving electrode extending along one side of said channel for the contact of the droplet to be transported.

2. The droplet microfluidic transporting module as claimed in claim 1, wherein said at least one microfluidic transporting platform is flexible.

3. The droplet microfluidic transporting module as claimed in claim 1, wherein each passage of each said connector extends in two-dimensional directions for guiding said droplet in the two-dimensional directions.

4. The droplet microfluidic transporting module as claimed in claim 3, wherein each said microfluidic transporting platform is curved to enable said droplet to move in three-dimensional directions.

5. The droplet microfluidic transporting module as claimed in claim 1, wherein said at least one connector each comprises a first connection electrode disposed at each of two distal ends thereof; each said microfluidic transporting platform comprises a second connection electrode disposed at each of two distal ends thereof for electrically connecting to the first connection electrodes of said at least one connector.

6. The droplet microfluidic transporting module as claimed in claim 1, wherein the first driving electrode of each said connector comprises an intersection area, and the second driving electrode of each said microfluidic transporting platform comprises an intersection area facing the intersection area of the first driving electrode of one said connector.

7. The droplet microfluidic transporting module as claimed in claim 1, wherein one said connector comprises an input/output terminal electrically connected to the first driving electrode of each said connector for transmitting signal and receiving power supply.

8. The droplet microfluidic transporting module as claimed in claim 1, wherein said at least one connector is directly electrically connected to at least one fluidic analysis unit, keeping the passage of each said connector in communication with the inside of said at least one fluidic analysis unit.

9. The droplet microfluidic transporting module as claimed in claim 1, wherein said at least one microfluidic transporting platform is directly electrically connected to at least one fluidic analysis unit, keeping the channel of each said microfluidic transporting platform in communication with the inside of said at least one fluidic analysis unit.

10. The droplet microfluidic transporting module as claimed in claim 1, wherein each said connector comprises a conducting membrane, and the first driving electrode of each said connector is arranged on the conducting membrane of the respective connector.
